(19) United States
(12) Patent Application Publication
(10) Pub. No.: US 2026/0259302 A1
(43) Pub. Date: Sep. 3, 2026

(54) CONTEXT AWARE RADAR FOR IN-CABIN SENSING

(71) Applicant: Robert Bosch GmbH, Stuttgart (DE)

(72) Inventors: Ruofeng LIU, East Lansing, MI (US); Vivek JAIN, Sunnyvale, CA (US)

(21) Appl. No.: 19/068,371

(22) Filed: Mar. 3, 2025

(51) Int. Cl. G01S 7/40; G01S 13/88

(52) U.S. Cl. CPC G01S 7/4004; G01S 13/88

(57) ABSTRACT

A method for adjusting transmission and reception parameters of a wireless vehicle interior sensing system using radar signals is disclosed. The method includes transmitting and receiving radar signals in a vehicle interior, and storing context history in a context database. The context history includes a history of the physical environment and occupancy in the vehicle interior. Context history is combined with information generated using the radar signals to determine a current context of the vehicle interior, the context including a current occupancy and classification of the occupants. Based on the context, transmission and reception parameters of the radar signals are adjusted

### TECHNICAL FIELD

The present disclosure relates to performing sensing applications on the exterior and within the interior of a vehicle, and more particularly, to using radar to perform such sensing.

### BACKGROUND

Smart vehicle cabin implementations can enhance the user experience for occupants of a vehicle and may further increase their safety. The in-cabin radar is a commonly used sensor in smart cabin implementations that can enable a wide range of applications including but not limited to child presence detection, occupancy detection/classification, driver impairment detection, etc. Available in-cabin radars may interrogate the cabin by transmitting a fixed, predefined waveform and process the reception using a fixed algorithm that remains constant irrespective of the situation of the vehicle and changes in the in-cabin environment.

### SUMMARY

A method for adjusting transmission and reception parameters of a wireless vehicle interior sensing system using radar signals is disclosed. The method includes transmitting, using a transmitter, radar signals in an interior of a vehicle, and receiving, using a receiver, reflections of the radar signals. The method further includes storing, in a context database, context history associated with the vehicle, wherein the context history includes a history of a physical environment within the vehicle interior and a history of occupancy of the vehicle. Thereafter, the method includes combining, using a computing device having a context fusion engine, external input information including respective positions of the transmitter and the receiver, context history from the context database including the history of the physical environment and the history of occupancy, and information generated using the radar signals. Based on the combining, the method includes determining a current context of the interior of the vehicle based on the combining, wherein the current context includes a current occupancy of the vehicle and a classification of occupants of the vehicle. Based on the current context, the method includes adjusting, based on the current context of the interior of the vehicle, one or more transmission parameters of the transmitter and one or more reception parameters of the receiver, wherein the transmission parameters include a power level and a frequency of the radar signals transmitted by the transmitter, and wherein the reception parameters include a frequency band of interest of signals received by the receiver.

### BRIEF DESCRIPTION OF THE DRAWINGS

FIG. 1 shows a system 100 for training a neural network.

FIG. 2 shows a computer-implemented method 200 for training a neural network.

FIG. 3A shows an example of a system for in-vehicle sensing.

FIG. 3B shows an example of a radar configuration unit in a system for in-vehicle sensing.

FIG. 4A illustrates an example of a method for in-vehicle sensing.

FIG. 4B illustrates another example of a method for in-vehicle sensing.

FIG. 5 depicts a schematic diagram of an interaction between computer-controlled machine 510 and control system 512.

FIG. 6 depicts a schematic diagram of the control system of FIG. 1 configured perform control functions within a vehicle.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In-cabin radar sensing (i.e. within the interior of a vehicle) has a wide range of applications (e.g., occupant monitoring and child presence detection). However, implementing in-cabin radar sensing can be challenging due to the complexity of the cabin environment in various aspects (e.g., rich multipath, occlusion, interference) and resource constraints of the radar sensing systems. Conventional radar sensing techniques are agnostic of these context factors. The present disclosure describes a novel in-cabin radar framework that incorporates various context information into the radar operation. The disclosure further introduces the concept, categories of context, and the adaptive transmission and reception pipeline that take the context into consideration.

The context-aware radar design of the present disclosure is designed to enhance in-cabin radar system performance through 1) obtaining static and dynamic context information from various sources to achieve “situational awareness”, 2) a continuous and coordinated feedback between the transmitter and receiver which implies a dynamic adaptation of the sensor's algorithms to the operational context and environmental replies.

The benefits of context-awareness in in-cabin radar sensing are multi-fold. First, the context (e.g., the interior structure of the car) imply constraints in the algorithm and can be applied to improve robustness of the sensing results (e.g., by adjusting transmission and reception parameters of a radar transmitter and receiver, respectively). Moreover, context can be considered by the sensing algorithm as additional features, semantics or situation elements are added. Additionally, in the resource constrained situation, radar is required to be adaptable to achieve various performance trade-offs. Various operational contexts are critical factors to determine the tradeoff.

The interior sensing of the present disclosure can enhance user experience and safety. The in-cabin radar and the context sensing carried out as described below enables a wide range of applications including but not limited to child presence detection, occupancy detection/classification, driver impairment detection, etc. The conventional radar interrogates the cabin by transmitting a fixed, predefined waveform and processed the reception using a fixed algorithm regardless of situation of the vehicle and changes in the in-cabin environment. As the result, the performance is suboptimal and could be highly sensitive to the change of the environment (rich multipath, occlusion, etc.). The present disclosure may overcome these issues by adjusting the sensing based on the context. In some embodiments, machine learning algorithms may be combined with the context history and the data generated by the radar signals to further enhance interior sensing.

Accordingly, the present disclosure includes a method for adjusting transmission and reception parameters of a wireless vehicle interior sensing system using radar signals. Radar signals are transmitted and received in a vehicle, while context history is stored in a context database. The context history includes historical information about the physical environment of the vehicle interior, occupancy history, classification of occupants, and so on. The context history is combined with information generated from received radar signals to determine a current context of the vehicle. Based on the context, transmission and reception parameters of the radar signals are adjusted to for more effective sensing of the context and changes thereto.

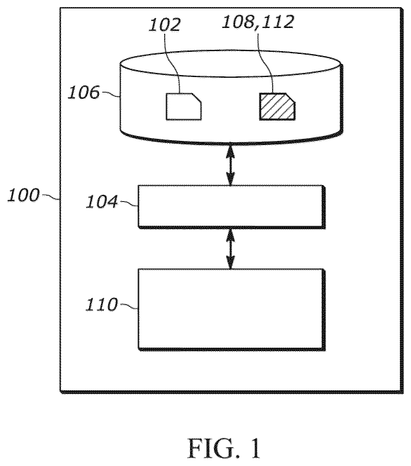

FIG. 1 shows a system 100 for training a neural network, e.g., a deep neural network. The neural network or deep neural networks shown and described are merely examples of the types of machine learning networks or neural networks that can be used. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input and output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyper parameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

In various embodiments, the system for training a neural network may be implemented in a system for interior vehicle sensing using in-cabin radar. Using the in-cabin radar and a context history database, a current context in the vehicle cabin may be determined. The context includes a number of occupants of the vehicle as well as the classification thereof (e.g., adults, children, pets, etc.). Other factors of the context may also be determined, such as alertness or impairment of the vehicle driver and/or passengers, whether windows are open or closed, whether passengers are sleeping or awake, and so on. In some embodiments, the context may also include personal identification for some occupants of the vehicle (e.g., an owner/driver). Historical context information, along with the currently generated data based on the in-cabin radar may be used with the neural network described above in order to determine a present context. This may include, for example, using a neural network to carry out classification tasks to classify the occupants of the vehicle, including personal identification.

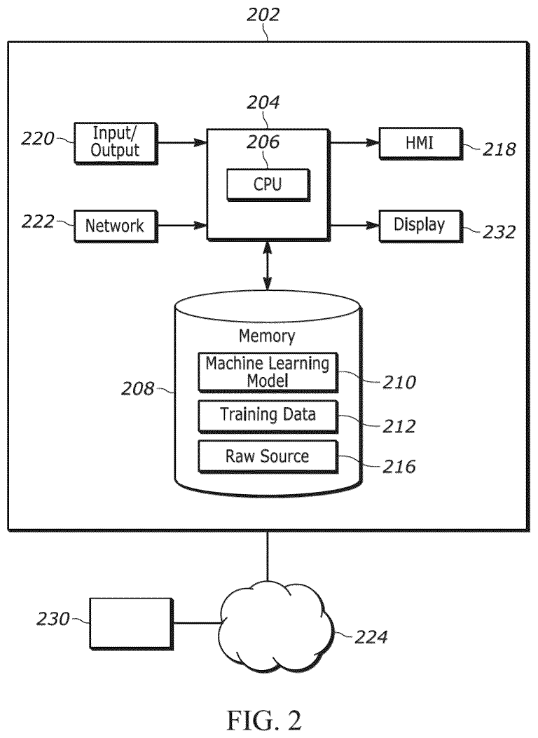

FIG. 2 depicts a system 200 to implement the machine learning models described herein, for example the deep neural networks used to determine a context of a vehicle interior using in-cabin radar sensing and to adjust radar parameters accordingly. Other types of machine learning models can be used, and the DNNs described herein are not the only types of machine learning models capable of being used in the system of this disclosure. For example, if the input radar image contains an ordered sequence of points (of a point cloud) CSI values to points in the radar image), a CNN may be utilized. The system 200 can be implemented to perform one or more of the phases of image recognition described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine learning model 210 or algorithm, a training dataset 212 for the machine learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G, 6G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines; timing and counting facilities, and other structure known to provide such functions. Examples of input devices include a keyboard, mouse, sensors, etc. Examples of output devices include monitors, printers, speakers, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine learning algorithm 210 that is configured to analyze the raw source dataset 216. The raw source dataset 216 may include raw or unprocessed sensor data that may be representative of an input dataset for a machine learning system. The raw source dataset 216 may include raw or partially processed sensor data (e.g., radar map of objects), wireless signals in terms of CSI, RSSI, CIR. Moreover, the raw source dataset 216 may be input data derived from an associated sensor such as a camera, lidar, radar, ultrasonic sensor, motion sensor, thermal imaging camera, wireless receivers, or any other type of sensor that produces associated data with spatial dimensions where there is some notion of a “foreground” and a “background” within those spatial dimensions. References to an input or input “image” herein is not necessarily from a camera, but can be from any of the above-listed sensors. In some examples, the machine learning algorithm 210 may be a neural network algorithm (e.g., deep neural network) that is designed to perform a predetermined function. For example, the neural network algorithm may be configured to identify defects (e.g., cracks, stresses, bumps, etc.) in a part subsequent to the manufacture of that part but prior to leaving the plant.

The computer system 200 may store a training dataset 212 for the machine learning algorithm 210. The training dataset 212 may represent a set of previously constructed data for training the machine learning algorithm 210. The training dataset 212 may be used by the machine learning algorithm 210 to learn weighting factors associated with a neural network algorithm. The training dataset 212 may include a set of source data that has corresponding outcomes or results that the machine learning algorithm 210 tries to duplicate via the learning process.

The machine learning algorithm 210 may be operated in a learning mode using the training dataset 212 as input. The machine learning algorithm 210 may be executed over a number of iterations using the data from the training dataset 212. With each iteration, the machine learning algorithm 210 may update internal weighting factors based on the achieved results. For example, the machine learning algorithm 210 can compare output results (e.g., a reconstructed or supplemented image, in the case where image data is the input) with those included in the training dataset 212. Since the training dataset 212 includes the expected results, the machine learning algorithm 210 can determine when performance is acceptable. After the machine learning algorithm 210 achieves a predetermined performance level (e.g., 100% agreement with the outcomes associated with the training dataset 212), or convergence, the machine learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine learning algorithm 210 may be applied to new datasets to generate annotated data.

The machine learning algorithm 210 may be configured to identify a particular feature in the raw source data 216. The raw source data 216 may include a plurality of instances or input dataset for which supplementation results are desired. The machine learning algorithm 210 may be programmed to process the raw source data 216 to identify the presence of the particular features. The machine learning algorithm 210 may be configured to identify a feature in the raw source data 216 as a predetermined feature. The machine learning algorithm may be further configured to identify human occupancy within a vehicle, gestures of occupants, breathing patterns, and so on. The raw source data 216 may be derived from a variety of sources. For example, the raw source data 216 may be actual input data collected by a machine learning system. The raw source data 216 may be machine generated for testing the system. As an example, the raw source data 216 may include data indicative of a physical context (e.g., interior of the vehicle), an operating context (e.g., vehicle moving, vehicle parked, etc.), a radio frequency (RF) context (e.g., interference present), and computing context (e.g., battery state, performance demands, etc.), and so on.

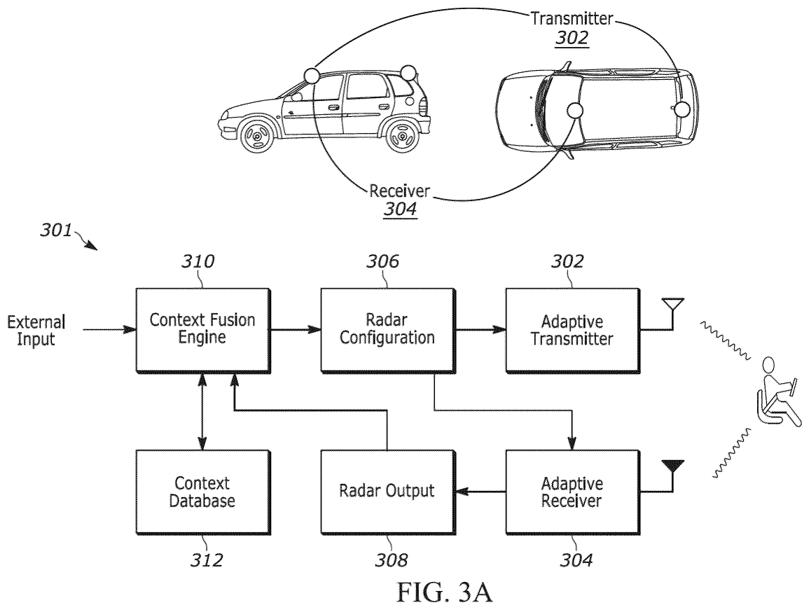

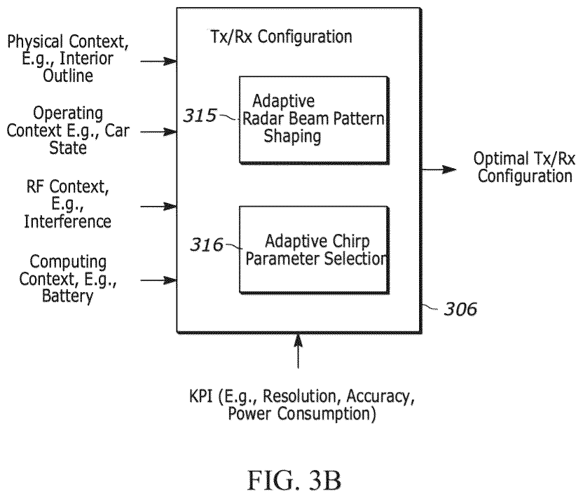

FIG. 3A is a diagram of one embodiment of a system implementing a context aware radar for in-cabin sensing in a vehicle interior. In the example shown, a vehicle includes an adaptive transmitter 302 and an adaptive receiver 304. Some embodiments may include additional transmitters and/or receivers. The adaptive transmitter 302 may transmit wireless signals in the vehicle, while the receiver may receive portions of the transmitted signals, either via a line-of-sight or reflections off various surfaces. Adaptive receiver 304 as shown herein includes directional capability to determine a direction from which signals are received. The strength of received signals from various directions within the vehicle may be used to determine factors such as the number of occupants of the vehicle, classification of occupants (e.g., adult, child, pet), which seats in the vehicle are occupied, status of occupants (e.g., sleeping, awake, impaired, etc.). In some embodiments, personal identification may also be carried out using the radar signals exchanged between adaptive transmitter 302 and adaptive receiver 304.

The block diagram of FIG. 3A further illustrates components of system 301, including context fusion engine 310, context database 312 (which may be located within storage unit 208 as shown in FIG. 2), radar configuration unit 306, and radar output unit 308, along with an adaptive transmitter 302 and adaptive receiver 304.

Context fusion engine 310 as shown here carries out a number of functions within system 301. A first function is to integrate information from external inputs, from context database 312, and from radar output 308. The external inputs may include information concerning whether the vehicle is in motion or parked, speed of the vehicle (if in motion), location of the vehicle (e.g., from GPS and/or mapping apps), whether seat belts are fastened or not fastened, approximate weight of seat occupants (in implementations where seats include weight sensors), and so on. Information from the context database comprise historical context information within the vehicle. As defined herein, the context within the vehicle is defined as a state of the vehicle within the interior/cabin, including number of occupants, types of occupants, and so on. As context fusion engine 310 makes decisions regarding the context of the vehicle based on its various inputs, the information is stored and used in the decision making process for future iterations. Context fusion engine 310 may also comprise a machine learning model, such as machine learning model 210 of FIG. 2. Furthermore, system 202 shown in FIG. 2 may carry out various functions associated with the context fusion engine 310. For example, the context fusion engine 310 may include instructions stored in memory 208 (including the machine learning model 210) that are executed by CPU 206.

Context information may come in a variety of categories, including physical context, user/operating context, a radio frequency (RF) context, and a computing context. The physical context may include information such as interior outline of the vehicle, radar position (i.e. position of transmitters and receivers within the vehicle), the presence of dedicated reflectors including reconfigurable intelligent surface, materials within the vehicle, the state of one or more electric car seats, state of the windows and doors (e.g., open or closed), and so on. Information regarding the physical context may be provided by the manufacture of the vehicle and other in-vehicle electronic systems.

The user/operating context includes information such as a car state (whether car is driving or not, speed of motion, engine running, etc.), state of weight sensors under the seats (e.g., to help determine a classification of a seat occupant), and state of seat belts (fastened or unfastened). This information may be provided by, e.g., one or more electronic systems within the vehicle. The status of the vehicle may have significant implications to the radar sensing carried out. For example, if the car is in motion, it can be assumed that the driver's seat is occupied and thus control of the in-vehicle radar sensing may be adjusted accordingly.

The RF context includes information regarding the presences of other RF signals within the vehicle interior. This may include the presence of UWB signals, Wi-Fi signals, cellular signals, and wirelessly transmitted and received signals. The information may include the frequency of the signals, but may include other signal characteristics such as amplitude, type of modulation (e.g., frequency modulation, amplitude modulation), information regarding spread spectrum signals, location of various transmitters, external electromagnetic interference, the presence of jamming signals and other friendly radars, and so on. This information may be sourced from in-vehicle radio receiver, including (but not limited to) adaptive receiver 304, and may be used to adjust various parameters, such as the radar duty cycle, for the purpose of mitigating interference.

The computing context includes information regarding network connectivity of various devices within the vehicle, communications bandwidth, power/battery status, available computing/processing resources, and so on. This information may be sources from other electronic/computing systems within the vehicle. The available computing resources may be taken into consideration when performing adjustments to the in-vehicle sensing system.

Using the combination of various context information, the context fusion engine 310 adjusts the transmission parameters at the adaptive transmitter 302 and the data processing at the adaptive receiver 304 to optimize the sensing performance. Finally, the context, the generated configuration and sensing results (e.g., performance) is saved to the context database 312 along with metadata.

Upon making a context decision in a particular iteration, context fusion engine 310 causes radar configuration unit 306 to update transmission and reception parameters for both adaptive transmitter 302 and adaptive receiver 304 to optimize the sensing performance. Transmission parameters updated by radar configuration unit 306 may include signal strength, beam pattern and beam shape, frequency channel, number of receive channels (when more than one available), modulation type and respective parameters—e.g. FMCW radar (which may include initial frequency, chirp bandwidth, chirp duration, chirp slope, chirp rate, modulation type, and repetition rate), pulse radar (amplitude, number of pulses, pulse repetition frequency, duration, shape of pulse, etc.), OFDM radar (number of sub-carriers, bandwidth, symbol duration, sample rate, modulation type, sub-carrier frequency spacing, etc.), transmit antenna, and transmit channel. Reception parameters updated by radar configuration unit 306 include adaptive constant false alarm rate detection, adaptive data processing and application-specific units, receive antenna, and receive channel. These parameters are now discussed in further detail with reference to FIG. 3B.

In the example shown, with one transmitter and one receiver, the entirety of the data pipeline may be implemented at the radar devices themselves. However, the disclosure contemplates implementations which include multiple transmitters and/or multiple receivers, with the functions of context fusion engine being implemented in a central computing device. In various embodiments, irrespective of the number of transmitters and receivers, machine learning and various signal processing techniques may be utilized for configuration of the transmitters and receivers.

When multiple in-cabin radars operate in the vehicle, the context fusion happens at a central device. The central device may further employ signal processing or machine learning techniques and jointly configure the radar devices.

FIG. 3B shows an example of a radar configuration unit in a system for in-vehicle sensing. Radar configuration unit 306 in the illustrated example receives various inputs and, using these inputs, generates transmission and reception parameters for adaptive transmitter 302 and adaptive receiver 304, respectively.

The inputs provided to radar configuration unit 306 include a physical context (e.g., outline of the vehicle interior), operating context (e.g., state within the vehicle interior, as defined above), RF context (e.g., signal interference due to reflections, etc.), and a computing context (e.g., processing workload, power status including status of a battery in embodiments that utilize battery power, etc.). Additionally, radar configuration unit 306 in the illustrated example receives key performance indicators (KPI), which are metrics defining certain desired system operating characteristics. These indicators include a resolution for objects (including occupants) detected in the vehicle interior, accuracy of object detection, and power consumption, among others.

Based on the context inputs and key performance indicators (KPIs), radar configuration unit 306 adjusts various radar transmission parameters such as bandwidth, the number of samples per chirp and the chirp duration to strike a balance between various resources while guaranteeing KPIs. In addition, the transmit parameters can be adjusted according to the RF context to mitigate the interference between radar and coexisting radios.

Radar configuration unit 306 includes an adaptive radar beam pattern-shaping unit 315 and an adaptive chirp parameter selection unit 316. With regard to the beam pattern and shape, the context fusion engine 310 may detect, based on the context and the received signal, that some angles might have strong unwanted returns. In response, the context fusion engine 310 may cause radar configuration unit 306 to shape the transmit beam pattern to exhibit small gain values in the desired directions and thus to suppress interference caused by unwanted returns. This may in turn aid in preventing a processor from overloading with data from signal detections that are unwanted and/or unimportant. Furthermore, monitoring of multiple targets within the vehicle interior can be accomplished via multiple beams in the transmit beam pattern (which may be adaptively interleaved with search beams), to enhance the functionality of the system and provide more accurate context information (and thus, better context decisions).

The adaptive chirp parameter selection unit 316 selects various chirp parameters for radar signals to be transmitted by adaptive transmitter 302. The chirp parameters include an initial, or starting frequency of the chirp signal at which it begins it sweep. If the chirp is a linear chirp, the frequency may increase or decrease linearly over the duration of the chirp. The chirp bandwidth refers to the total range of frequencies that the chirp sweeps through (i.e. the difference between the starting and ending frequencies). The chirp duration refers to the total time over which the frequency sweep occurs. The chirp slope is the rate at which the frequency changes over time during the sweep (and is expressed in terms of frequency change per unit time in a linear sweep). Modulation type defines the way in which the signal frequency changes over time (e.g., frequency modulation). The repetition rate refers to the rate at which the chirp is repeated. Each of these parameters may be adjusted based on the context and KPI input to radar configuration unit 306.

With regard to adjusting the reception parameters, the context fusion engine 310 may cause radar configuration unit to adaptively adjust a threshold level for detecting a target in the presence of noise and clutter. By combing the physical context and received signal, the algorithm can detect the presence of a range cell that contains a strong clutter thereby take subsequent actions for training data, outlier rejection, and so on. Furthermore, since the distribution of noise may depend on the context, the reception thresholds are adjusted accordingly in various implementations.

Adjusting the reception parameters in various implementations includes adaptive data processing and the use of application-specific units. A raw radar point cloud is commonly noisy, suffering from the multi-path reflection and interference. These outlier and ghost points can be removed from three-dimensional point cloud to provide more accurate data for subsequent processing. Knowing the physical context of the in-cabin environment can help to get rid of the ghost points that appear in various locations. Application-specific algorithms carried out by context fusion engine 310 may use the point cloud in making a decision. The context as determined by context fusion engine 310 can be considered as an additional sensor. Accordingly, the system can adopt a multi-modal sensor fusion method to fuse the context with the radar sensor data in determining how the reception parameters are adjusted (e.g., in determining which points of a point cloud are to be discarded).

Based on the above, radar configuration unit 306 determines optimal configurations for adaptive transmitter 302 and adaptive receiver 304. Based on the optimal configurations radar configuration unit 306 generates control signals to cause both adaptive transmitter 302 and adaptive receive 304 to make the corresponding adjustments.

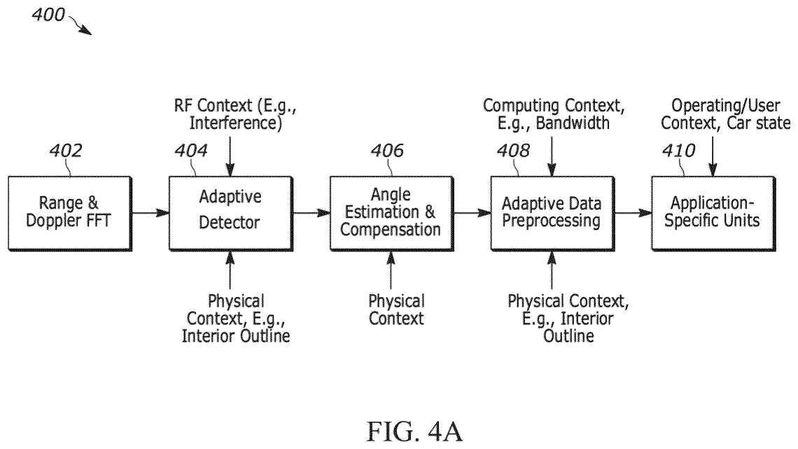

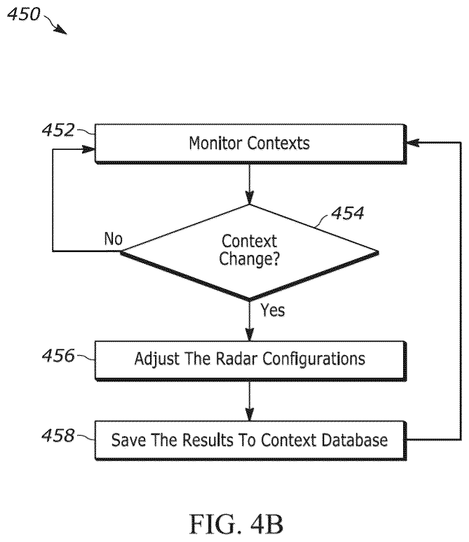

FIG. 4A illustrates an example of a method for in-vehicle sensing. Method 400 illustrates one possible flow of operations in the systems discussed above. Other systems not explicitly disclosed herein but capable of carrying out Method 400 are considered to fall within the scope of this disclosure.

The method as illustrated in FIG. 4A begins with the receiving of radar signals and performing range and Doppler pre-processing thereon, including the performing of Fast Fourier Transforms (FFT; block 402). In one embodiment, the pre-processing may generate point cloud data. The pre-processed data is then forwarded to an adaptive detection block (block 404). The RF context and physical context within the vehicle are combined with the adaptive detector to make further estimations regarding the context within the vehicle. Thereafter, angle estimation and compensation (block 406) is performed on the detected data to remove interference from the data and to further refine the determination of the in-vehicle context.

The refined vehicle context is then subject to adaptive data pre-processing (block 408), in combination with computing context data and the physical context data within the vehicle. This may produce vehicle context information that is subject to a final refinement, in combination with the most recent operating/user context and car state data to generate control inputs for application-specific units (block 410). This includes control inputs to the radar configuration unit, which generates further control inputs for the adaptive transmitter 302 and adaptive receiver 304. Additional control inputs may be provided to other units within the vehicle, such as other radio transmitters (e.g., Wi-Fi transmitter) to control interference.

FIG. 4B illustrates another example of a method for in-vehicle sensing. Method 450 may be carried out by various embodiments of the systems discussed in FIGS. 3A and 3B. Other systems not explicitly disclosed herein but capable of carrying out Method 450 are considered to fall within the scope of this disclosure.

Method 450 includes the monitoring of contexts within a vehicle (block 452). This monitoring may be carried out using the various techniques discussed above to determine the in-vehicle contexts, such as the vehicle occupants, classification (and in some cases identification of vehicle occupants), and so on.

Method 450 further included determining whether a context change has occurred. If a context change has not occurred (block 454, No), the method continues the monitoring of the context per Block 452. If a context change has occurred (block 454, Yes), then the radar configuration is adjusted (block 456) to respond to the next context. One such example of a context change may be an occupant leaving the vehicle at a stop before continuing to another destination. The new context may be saved to the context database (block 458) before the method returns to block 452.

The various systems and methods disclosed herein may be used in a wide variety of applications. Such applications may include occupant detection, occupant identification, child presence detection, presence/intrusion detection, gait recognition (for a person approaching the vehicle), proximity sensing (kick sensor), parking assistance, blind spot detection, detection of relay attacks, gestures, activity detection, and so on.

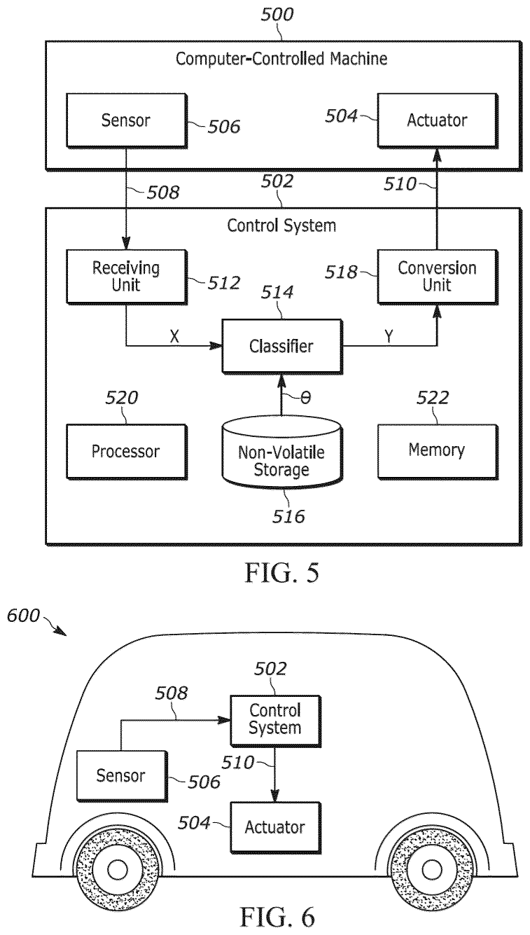

FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506, which can include a transmitter and a receiver as discussed above, is configured to sense a condition of computer-controlled machine 500. Sensor 506 may be configured to encode the sensed condition into sensor signals 508 and to transmit sensor signals 508 to control system 502. Non-limiting examples of sensor 506 include wireless receivers, video, radar, LiDAR, ultrasonic and motion sensors, as described above with reference to FIGS. 1-2. In one embodiment, sensor 506 is a wireless sensor configured to sense an environment proximate to computer-controlled machine 500. Embodiments in which a combination of different sensors are also possible and contemplated.

Sensor 506 may also be, in various embodiments, an in-cabin radar configured for use in a vehicle interior. Computer-controlled machine may utilize radar signals generated and received by the in-cabin radar to determine various information such as the number and classification of occupants within a vehicle interior, status of occupants within the vehicle, and personal identification of one or more occupants of the vehicle.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to a radar image (e.g., a point cloud) recorded by sensor 506.

Control system 502 includes a classifier 514. Classifier 514 may be configured to classify input signals x into one or more labels using a machine learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine learning algorithms, such as those described above with regard to pre-trained classifier 306) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, wireless transmitters and/or receivers, LiDAR sensors, and/or position sensors (e.g., GPS). One or more of the one or more specific sensors may be integrated into vehicle 600. Alternatively or in addition to one or more specific sensors identified above, sensor 506 may include a software module configured to, upon execution, determine a state of actuator 504.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects. In some embodiments, classifier 514 may utilize wireless signals (e.g., Bluetooth signals) in the vehicle for PID purposes in accordance with the discussion above. For example, classifier 514 may utilize the wireless signals to identify a particular driver of the car, thereby enabling control system 502 to adjust a seat position for the particular driver upon entry into the vehicle.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for adjusting transmission and reception parameters of a wireless vehicle interior sensing system using radar signals, the method comprising:
transmitting, using a transmitter, radar signals in an interior of a vehicle;
receiving, using a receiver, reflections of the radar signals;
storing, in a context database, context history associated with the vehicle, wherein the context history includes a history of a physical environment within the vehicle interior and a history of occupancy of the vehicle;
combining, using a computing device having a context fusion engine, (i) external input information including respective positions of the transmitter and the receiver, (ii) the context history from the context database including the history of the physical environment and the history of occupancy, and (iii) information generated using the radar signals;
determining a current context of the interior of the vehicle based on the combining, wherein the current context includes a current occupancy of the vehicle and a classification of occupants of the vehicle; and
adjusting, based on the current context of the interior of the vehicle, one or more transmission parameters of the transmitter and one or more reception parameters of the receiver.

2. The method of claim 1, wherein the one or more transmission parameters include a beam pattern shape of the radar signals.

3. The method of claim 1, wherein the one or more transmission parameters include one or more of the following:
signal strength;
beam pattern;
beam shape;
frequency channel;
modulation type;
chirp bandwidth;
chirp duration;
chirp slope;
chirp rate;
repetition rate;
amplitude;
pulse shape;
number of sub-carriers;
transmit antenna;
transmit channel;
receive antenna; and
receive channel.

4. The method of claim 1, wherein the one or more reception parameters include at least one reception signal level threshold and a frequency band of interest of signals received by the receiver.

5. The method of claim 1, wherein the current context further includes one or more of the following parameters of a physical environment of interior of the vehicle:
a position of one or more seats;
a state of one or more windows of the vehicle;
an outline of the interior of the vehicle.

6. The method of claim 1, wherein the current context further includes one or more of the following parameters of an operating context of the vehicle:
a determination of whether the vehicle is moving;
a state of one or more seat belts in the vehicle;
information provided from weight sensors in seats of the vehicle.

7. The method of claim 1, wherein the current context includes one or more of the following radio parameters within the interior of the vehicle:
presence of additional transmitters;
respective frequencies of radio signals transmitted within the interior of the vehicle;
electromagnetic interference in the vehicle from external sources;
modulation of radio signals transmitted within the vehicle.

8. The method of claim 1, wherein the current context includes one or more of the following computing parameters within the interior of the vehicle:
network connections for one or more wireless communications devices within the interior of the vehicle;
communications bandwidth for wireless communications devices within the interior of the vehicle;
costs to utilize communications resources by the one or more wireless communications devices within the vehicle.

9. The method of claim 1, further comprising:
determining, using the computing device, ghost points in three-dimensional point cloud data generated using the radar signals, the ghost points being indicative of interference with the radar signals; and
using the current context and context history to remove the ghost points.

10. A system for adjusting transmission and reception parameters of a wireless vehicle interior sensing system using radar signals, the system comprising:
a transmitter configured to transmit radar signals in an interior of a vehicle;
a receiver configured to receive reflections of the radar signals; and
a computing system comprising:
a context database configured to store context history associated with the vehicle, wherein the context history includes a history of a physical environment within the vehicle interior and a history of occupancy of the vehicle;
a context fusion engine configured to combine (i) external input information including respective positions of the transmitter and the receiver, (ii) the context history from the context database including the history of the physical environment and the history of occupancy, and (iii) information generated using the radar signals to determine a current context of the interior of the vehicle, wherein the current context includes a current occupancy of the vehicle and a classification of occupants of the vehicle; and
a radar configuration unit configured to adjust, based on the current context of the interior of the vehicle, one or more transmission parameters of the transmitter and one or more reception parameters of the receiver.

11. The system of claim 10, wherein the radar configuration unit is further configured to adjust transmission parameters including
one or more of the following:
signal strength;
beam pattern;
beam shape;
frequency channel;
modulation type;
chirp bandwidth;
chirp duration;
chirp slope;
chirp rate;
repetition rate;
amplitude;
pulse shape;
number of sub-carriers;
transmit antenna;
transmit channel;
receive antenna; and
receive channel.

12. The system of claim 10, wherein the radar configuration unit is further configured to adjust reception parameters including at least one reception signal level threshold and a frequency band of interest of signals received by the receiver.

13. The system of claim 10, wherein the current context further includes one or more of the following parameters of a physical environment of interior of the vehicle:
a position of one or more seats;
a state of one or more windows of the vehicle;
an outline of the interior of the vehicle.

14. The system of claim 10, wherein the current context further includes one or more of the following parameters of an operating context of the vehicle:
a determination of whether the vehicle is moving;
a state of one or more seat belts in the vehicle;
information provided from weight sensors in seats of the vehicle.

15. The system of claim 10, wherein the current context includes one or more of the following radio parameters within the interior of the vehicle:
presence of additional transmitters;
respective frequencies of radio signals transmitted within the interior of the vehicle;
electromagnetic interference in the vehicle from external sources;
modulation of radio signals transmitted within the vehicle.

16. The system of claim 10, wherein the current context includes one or more of the following computing parameters within the interior of the vehicle:
network connections for one or more wireless communications devices within the interior of the vehicle;
communications bandwidth for wireless communications devices within the interior of the vehicle;
costs to utilize communications resources by the one or more wireless communications devices within the vehicle.

17. The system of claim 10, wherein the computing system is further configured to:
determine ghost points in three-dimensional point cloud data generated using the radar signals, the ghost points being indicative of interference with the radar signals; and
using the current context and context history to remove the ghost points.

18. A non-transitory computer-readable medium storing instructions that, when executed on a computing system, cause the computing system to carry out operations comprising:
causing a transmitter to transmit radar signals in an interior of a vehicle;
causing a receiver to receive reflections of the radar signals;
storing, in a context database, context history associated with the vehicle, wherein the context history includes a history of a physical environment within the vehicle interior and a history of occupancy of the vehicle;
combining, using a context fusion engine, external input information including respective positions of the transmitter and the receiver, context history from the context database including the history of the physical environment and the history of occupancy, and information generated using the radar signals;
determining a current context of the interior of the vehicle based on the combining, wherein the current context includes a current occupancy of the vehicle and a classification of occupants of the vehicle; and
causing adjustment of, based on the current context of the interior of the vehicle, one or more transmission parameters of the transmitter and one or more reception parameters of the receiver.

19. The computer-readable medium of claim 18, wherein the one or more transmission parameters include a beam pattern shape of the radar signals and one or more chirp parameters including a number of samples of a chirp, a duration of the chirp, starting and ending frequencies of the chirp, and a power level of the chirp, and wherein the one or more reception parameters include at least one reception signal level threshold and a frequency band of interest of signals received by the receiver.

20. The computer-readable medium of claim 18, wherein the current context further includes:
one or more of the following parameters of a physical environment of interior of the vehicle:
a position of one or more seats;
a state of one or more windows of the vehicle;
an outline of the interior of the vehicle;
one or more of the following parameters of an operating context of the vehicle:
a determination of whether the vehicle is moving;
a state of one or more seat belts in the vehicle;
information provided from weight sensors in seats of the vehicle;
one or more of the following radio parameters within the interior of the vehicle:
presence of additional transmitters;
respective frequencies of radio signals transmitted within the interior of the vehicle;
electromagnetic interference in the vehicle from external sources;
modulation of radio signals transmitted within the vehicle; and
one or more of the following computing parameters within the interior of the vehicle:
network connections for one or more wireless communications devices within the interior of the vehicle;
communications bandwidth for wireless communications devices within the interior of the vehicle;
costs to utilize communications resources by the one or more wireless communications devices within the vehicle.
